(19) United States
(12) Patent Application Publication
(10) Pub. No.: US 2009/0185292 A1
(43) Pub. Date: Jul. 23, 2009

(54) Imaging lens module

(75) Inventor: Fei-Hsin Tsai, Taichung (TW)

Correspondence Address: Fei-Hsin Tsai, P.O.Box 44-2049, Taipei, 10668, TW

(73) Assignee: Newmax Technology Co. Ltd.

(21) Appl. No.: 12/007,908

(22) Filed: Jan. 17, 2008

(51) Int. Cl. G02B 9/34

(52) U.S. Cl. 359/771

(57) ABSTRACT

An imaging lens module includes a fixed diaphragm and an optical module. The optical module includes first, second, third and fourth lenses arranged from an object side to an image side in a sequence of: a diaphragm, the first lens being a double-convex lens, the second lens having a negative refractive power and a concave surface disposed towards the object side, the third lens having a positive refractive power and a meniscus lens with a convex surface disposed towards the image side, the fourth lens having a convex surface disposed towards the object side and a wavy surface disposed towards the image side and a concave surface disposed towards the image side near the optical axis. With the diaphragm of the imaging lens module and the lens arrangement of the optical module, the sensitivity of tolerance of a system can be lowered to achieve a high imaging quality and a good yield rate.

### BACKGROUND OF THE INVENTION

(1) Field of the Invention

The present invention relates to the field of optical lenses, and more particularly to an imaging lens module capable of lowering the sensitivity of tolerance of a system to improve the yield rate, and providing a better imaging quality.

(2) Description of the Prior Art

At present, digital carriers having a dynamic or static photograph function such as PC CAM, DSC or DVD and DV, etc tend to be designed with a light, thin, short, small and innovative structure, and thus the structure of components is miniaturized, particularly a lens module for controlling the photographing definitely requires such miniaturization for enhancing the weight and compactness of a digital carrier.

Digital video (DV) with static and dynamic photographing functions is a typical example of implementing the miniaturization to home appliance.

Due to the light and easy-to-carry features, the DV market has replaced the V8, Hi8 market in a few years. Although the DV available in the market comes with two major selling points respectively, the light and compact design and the high pixels to enhance its competitive edge, the high pixels emphasized by the present DV or other digital carriers is adversely affected by a poor camera design, and thus the sensitivity of tolerance of the system is too high, and the imaging quality of the DV is affected, and a poor yield rate is resulted.

Therefore, it is an important subject for manufacturers and designers to provide a high pixels four-lens optical lens module that can improve the imaging quality to meet the market requirements of digital carriers.

### SUMMARY OF THE INVENTION

The primary objective of the present invention is to provide a high-quality imaging lens module formed by four lenses and capable of lowering the sensitivity of tolerance of an imaging system to improve the yield rate of the imaging lens modules.

To achieve the foregoing objectives, the present invention provides an imaging lens comprising a fixed diaphragm and an optical module, and the optical module comprises first, second, third and fourth lenses arranged from an object side to an image side in the sequence of: the diaphragm; the first lens being a double-convex lens; the second lens, having a negative refractive power and a concave surface disposed towards the object side, and at least one surface being an aspheric surface; the third lens, having a positive refractive power and a meniscus lens with a convex surface disposed towards the image side, and at least one surface being an aspheric surface; the fourth lens, having a convex surface disposed towards the object side, and a wavy surface disposed towards the image side and a concave surface disposed towards the image side near the optical axis, and at least one surface being an aspheric surface.

The structural design of the imaging lens module will now be described in more detail hereinafter with reference to the accompanying drawings that show various embodiments of the invention.

### BRIEF DESCRIPTION OF THE DRAWINGS

FIG. 1 shows a schematic view of an imaging lens module in accordance with a first preferred embodiment of the present invention;

FIG. 1A shows a schematic view of the aberration of an imaging lens module in accordance with a first preferred embodiment of the present invention;

FIG. 1B shows a schematic view of the data of optical features and aspheric surface coefficients in accordance with a first preferred embodiment of the present invention;

FIG. 2 shows a perspective view of an imaging lens module composed of lenses in accordance with a second preferred embodiment of the present invention;

FIG. 2A shows a schematic view of the aberration of an imaging lens module of an imaging lens module in accordance with a second preferred embodiment of the present invention; and

FIG. 2B shows a schematic view of the data of optical features and aspheric surface coefficients of an imaging lens module in accordance with a second preferred embodiment of the present invention.

### DETAILED DESCRIPTION OF THE PREFERRED EMBODIMENTS

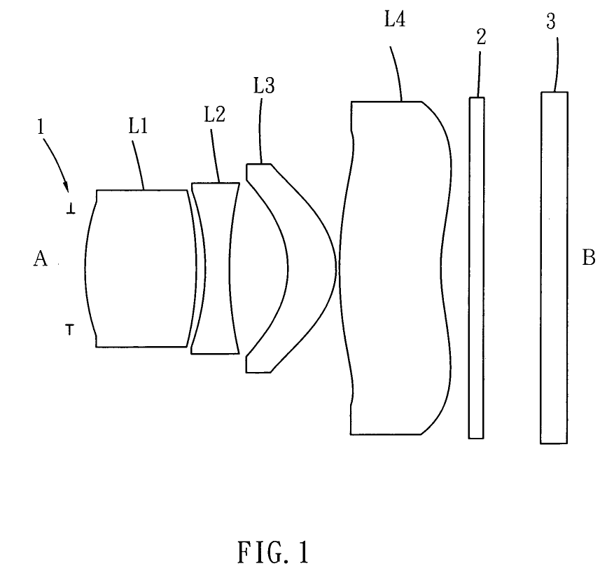

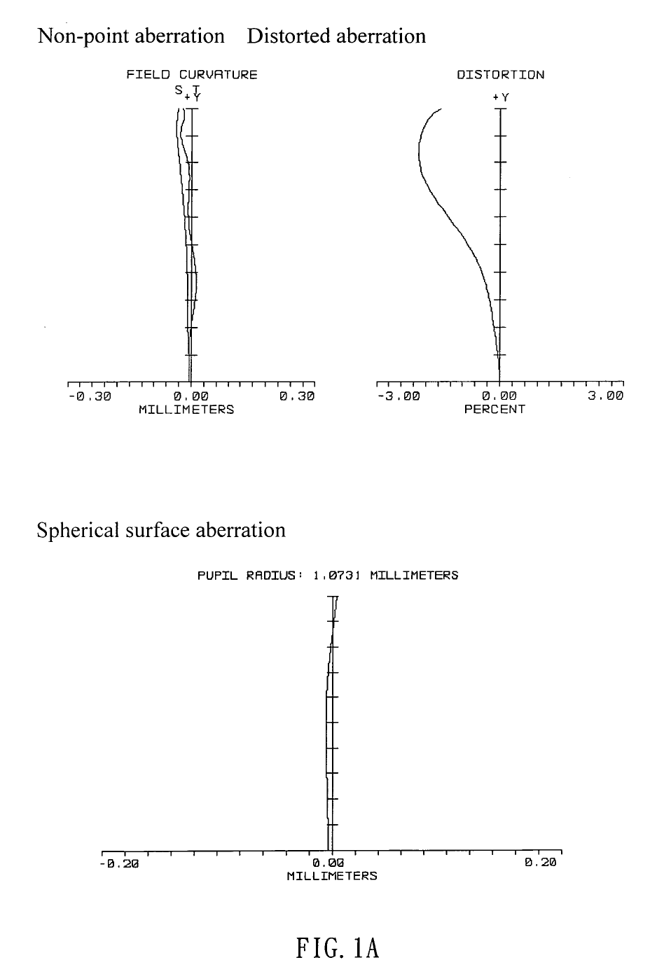

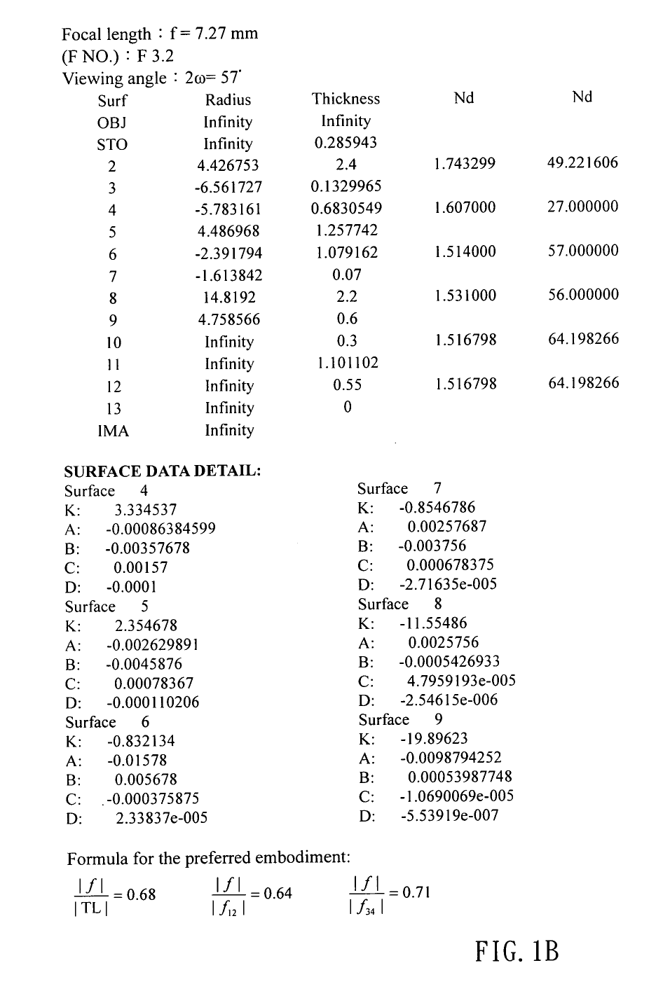

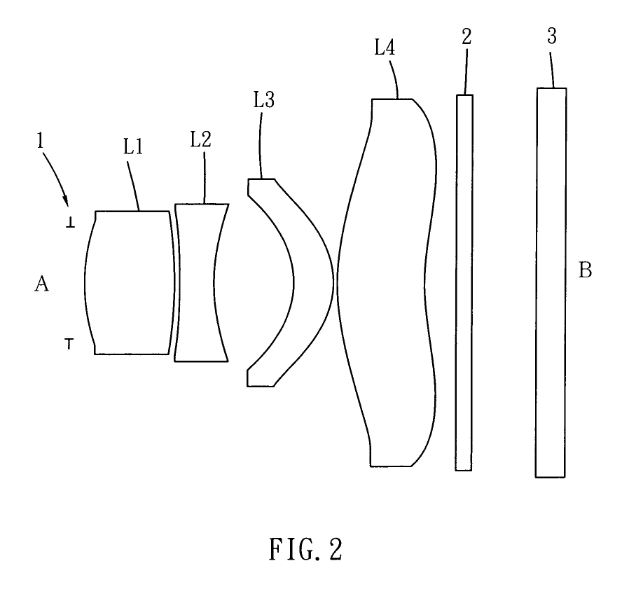

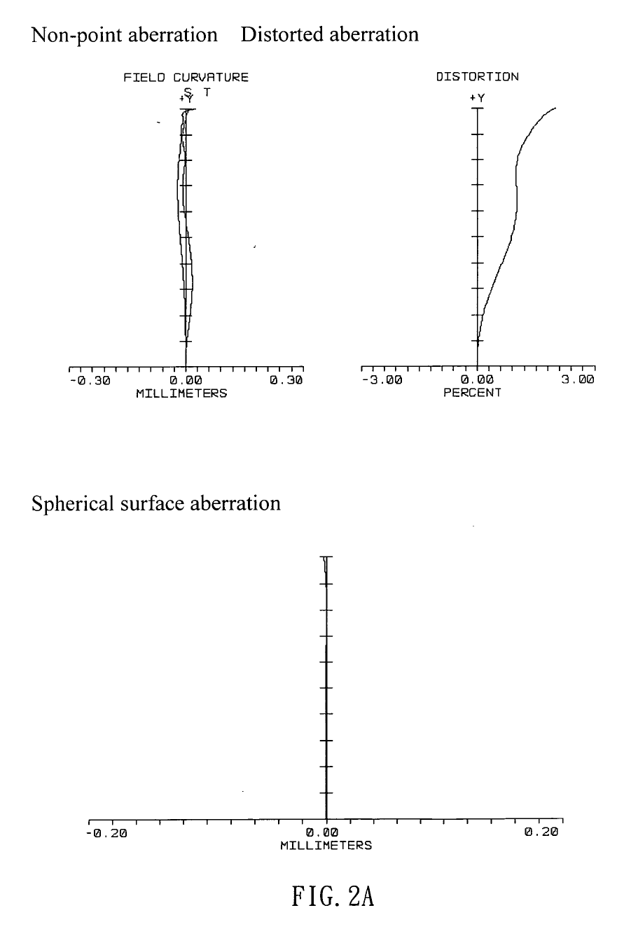

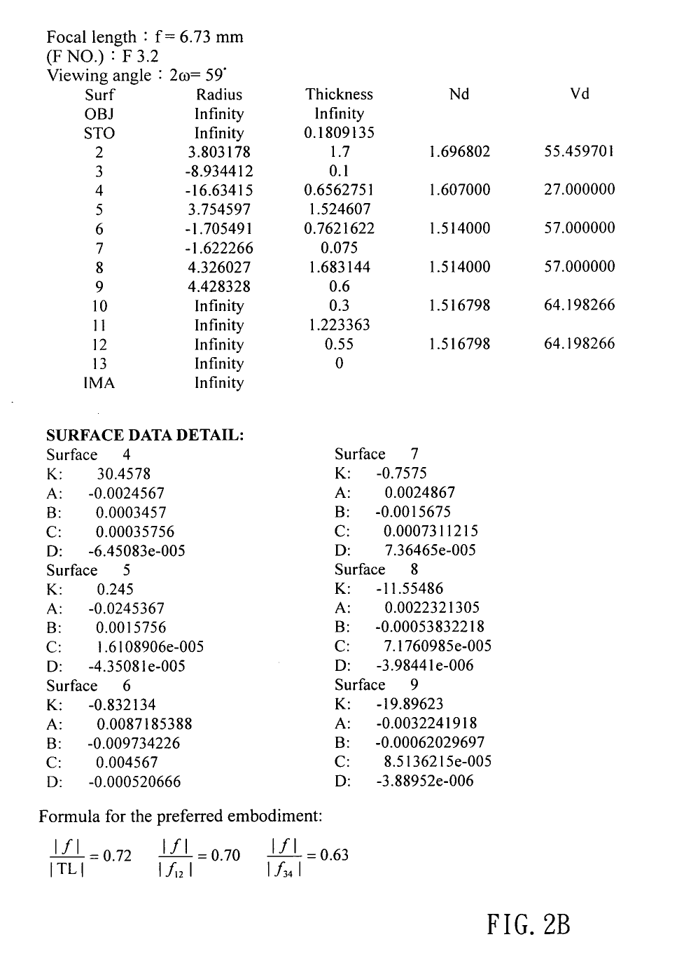

FIGS. 1 and 2 show schematic views of lens modules in accordance with the first and second preferred embodiments of the present invention respectively, and FIGS. 1A and 2A show schematic views of the aberrations of imaging lens modules in accordance with the two preferred embodiments of the present invention respectively, and FIGS. 1B and 2B show schematic views of the data of optical features and aspheric surface coefficients in accordance with the two preferred embodiments of the present invention respectively. Referring to FIGS. 1B and 2B, the change of numeric values of each preferred embodiment of the present invention is obtained by a simulated design. Even if different numeric values are used, products of the same structure still fall within the scope of claims of this invention.

Referring to FIG. 1 for a four-lens camera lens module of the invention, an imaging lens module is provided for installing a light, thin, short and compact digital carrier such as a digital camera, a mobile phone, particularly a DV camera, and the invention can maximize the effect of the imaging lens module. It is noteworthy to point out that the invention is not limited to the application of DV only.

In two preferred embodiments of the imaging lens module in accordance with the present invention, the imaging lens module comprises a fixed diaphragm 1 and an optical module disposed along an optical axis and in a sequence from an object side A, and the optical module comprises first, second, third and fourth lenses L1, L2, L3, L4, arranged from an object side A to an image side B in the sequence of: the diaphragm 1;

the first lens L1, being a double-convex lens, and the surface of the first lens L1 being an aspheric surface, for enhancing an imaging quality;
the second lens L2, having a negative refractive power and a concave surface disposed towards the object side A, and at least one surface being an aspheric surface;
the third lens L3, having a positive refractive power and a meniscus lens with a convex surface disposed towards the image side B, and at least one surface being an aspheric surface; and
the fourth lens L4, having a convex surface disposed towards the object side A, and a wavy surface disposed towards the image side B and a concave surface disposed towards the image side B near the optical axis, and at least one surface being an aspheric surface.

In the optical module composed of four lenses in accordance to the system of the invention, a first plane glass 2 is disposed behind the fourth lens L4, having a filtering infrared effect. In addition, a second plane glass 3 is installed before the image side B for providing an effect of protecting the light sensor and used for image sensors of different packages and providing a better imaging quality. Further, the image side B refers to a light sensor for capturing images, and the light sensor is a CCD or a CMOS.

In the imaging lens module of the invention, the optical module pre-installs the diaphragm 1, and then the first lens, second lens, third lens and fourth lens, and the surfaces of the second lens, third lens and fourth lens are designed as aspheric surfaces. In addition to the function of reducing the number of high resolution camera lenses, the invention also maximize the effect of suppressing the aberration, and thus the overall design of the optical module can greatly lower the sensitivity of tolerance of the system and enhance the yield rate to obtain a better imaging quality. Further, the pre-installed diaphragm 1 satisfies the conditions and requirements of an incident angle, which is helpful to the production of camera lenses and provide a high yield rate.

In the invention, the optical module of the imaging lens module must satisfy the following conditions:

0.5<f/TL<1

where, TL is the distance from the diaphragm 1 to the imaging surface B, and f is the focal length of the whole lens module;

$$0.5 < \frac{\vert f \vert}{\vert {f}_{12} \vert} < 0.85$$

where, f₁₂ is the overall focal length of the first lens L1 and the second lens L2, and f is the focal length of the whole lens module; and

$$0.5 < \frac{\vert f \vert}{\vert {f}_{34} \vert} < 0.85$$

where, f₃₄ is the overall focal length of the third lens L3 and the fourth lens L4, and f is the focal length of the whole lens module.

In the imaging lens module of the invention, the optical module satisfies the aforementioned conditions before the sensitivity of tolerance of the optical module can be lowered to enhance the yield rate. In the meantime, the imaging quality of the optical module is optimized. On the other hand, if the optical module is below or above each of the aforementioned conditions, there will be no significant effect on the sensitivity of tolerance of the optical module, the yield rate, and the imaging quality.

The schematic views of the aberration of the invention illustrate a non-point aberration, a distorted aberration and a spherical surface aberration as shown in FIGS. 1A and 2A. Regardless of which aberration, the aberration relates to a data of a line d, and the non-point aberration relates to the data of an S image plane (SAGITAL) which is related to the data of a T image plane (TANGENTIAL). From the figures of the aberrations, the correction of the aberration of the invention is obtained completely from a simulated design, and thus there will be no problems in practical applications.

Referring to FIGS. 1B and 2B for the data of aspheric surface of the first and second preferred embodiments of the present invention respectively, the data at the top represent the numerals of each lens and element of the optical module of the invention as follows:

The value of F. No. ˜the F value shows the parameter of brightness. The smaller the value of F, the higher is the brightness.
Angle of viewing˜2ω
Focal Length˜f; and f is the overall focal length (mm) of the optical module, and 2, 3, 4, 5, 6, 7, 8, 9, 10, 11, 12, 13 listed below are numbers of lenses counting in a sequence starting from the object side; and the surface numbers 2, 3 represent two surfaces of the first lens L1, and the surface numbers 4, 5 represent two surfaces of the second lens L2, and the surface numbers 6, 7 are two surfaces of a third lens L3, and the surface numbers 8, 9 are two surfaces of the fourth lens L4, and 10, 11, 12, 13 represent two surfaces of the first plane glass 2 and the second plane glass 3 respectively.

Since both surfaces of each lens of the optical module of the invention are aspheric surfaces, the shape of the aspheric surfaces must satisfy the conditions of the following formula:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Gh}^{14} + …$$

where, z is the value of a reference position with respect to a vertex of the surface along the optical axis and at a position with a height h;
k is a conic constant;
c is the reciprocal of a radius of curvature; and
A, B, C, D, E, G . . . are coefficients of high level aspheric surfaces.

With the pre-installed diaphragm and the installed first lens, second lens, third lens and fourth lens, the sensitivity of tolerance of the system can be lowered to enhance the yield rate and obtain a high imaging quality.

While we have shown and described the embodiment in accordance with the present invention, it should be clear to those skilled in the art that further embodiments may be made without departing from the scope of the present invention.

What is claimed is:

1. An imaging lens module, comprising a fixed diaphragm and an optical module, and the optical module comprising first, second, third and fourth lenses arranged from an object side to an image side in a sequence of:
the diaphragm;
the first lens, being a double-convex lens;
the second lens, having a negative refractive power and a concave surface disposed towards the object side, and at least one surface being a aspheric surface;
the third lens, having a positive refractive power and a meniscus lens with a convex surface disposed towards the image side, and at least one surface being an aspheric surface;
the fourth lens having a convex surface disposed towards the object side, and a wavy surface disposed towards the image side and a concave surface disposed towards the image side near the optical axis, and at least one surface being an aspheric surface.

2. The imaging lens module as claimed in claim 1, wherein at least one surface of the first lens is an aspheric surface.

3. The imaging lens module as claimed in claim 1, wherein 0.5<f/TL<1, and TL is the distance from the diaphragm to the imaging surface, and f is the focal length of the whole lens module.

4. The imaging lens module as claimed in claim 1, wherein
$$0.5 < \frac{\vert f \vert}{\vert {f}_{12} \vert} < 0.85$$
and f₁₂ is the overall focal length of the first lens and the second lens, and f is the focal length of the whole lens module.

5. The imaging lens module as claimed in claim 1, wherein
$$0.5 < \frac{\vert f \vert}{\vert {f}_{34} \vert} < 0.85$$
and f₃₄ is a overall focal length of the third lens and the fourth lens, and f is the focal length of the whole lens module.

6. The imaging lens module as claimed in claim 1, wherein the aspheric surface is in a shape satisfying the formula of:
$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Gh}^{14} + …$$
and z is the value of a reference position with respect to a vertex of the surface along the optical axis and at a position with a height h; k is a conic constant; c is the reciprocal of a radius of curvature; and A, B, C, D, E, G . . . are coefficients of high level aspheric surfaces.
